(19) United States
(12) Patent Application Publication
(10) Pub. No.: US 2022/0070659 A1
(43) Pub. Date: Mar. 3, 2022

(54) TECHNIQUES FOR CONTROLLING A PACKET DATA CONVERGENCE PROTOCOL MODE AT A USER EQUIPMENT

(71) Applicant: QUALCOMM Incorporated, San Diego, CA (US)

(72) Inventors: Arun Prasanth BALASUBRAMANIAN, San Diego, CA (US); Shailesh MAHESHWARI, San Diego, CA (US); Arnaud MEYLAN, San Diego, CA (US); Leena ZACHARIAS, San Jose, CA (US); Xing CHEN, San Diego, CA (US); Xiaojian LONG, San Diego, CA (US); Gang Andy XIAO, San Diego, CA (US)

(21) Appl. No.: 17/446,016

(22) Filed: Aug. 26, 2021

Related U.S. Application Data
(60) Provisional application No. 62/706,630, filed on Aug. 28, 2020.

(51) Int. Cl. H04W 8/22

(52) U.S. Cl. CPC H04W 8/22

(57) ABSTRACT

Various aspects of the present disclosure generally relate to wireless communication. In some aspects, a user equipment (UE) may monitor packet data convergence protocol (PDCP) counter values associated with PDCP packets. The UE may control a PDCP mode of the UE based at least in part on the monitoring of the PDCP counter values. Numerous other aspects are provided.

### CROSS-REFERENCE TO RELATED APPLICATION

This patent application claims priority to U.S. Provisional Patent Application No. 62/706,630, filed on Aug. 28, 2020, entitled “TECHNIQUES FOR CONTROLLING A PACKET DATA CONVERGENCE PROTOCOL MODE AT A USER EQUIPMENT,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for controlling a packet data convergence protocol mode at a user equipment.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a UE includes monitoring packet data convergence protocol (PDCP) counter values associated with PDCP packets; and controlling a PDCP mode of the UE based at least in part on the monitoring of the PDCP counter values.

In some aspects, the PDCP mode enables the UE to deliver, to an application of the UE, one or more PDCP packets without waiting for a time duration to expire, the one or more PDCP packets follow a gap in which a PDCP packet is not expected to be received at the UE.

In some aspects, monitoring the PDCP counter values comprises detecting an out-of-order PDCP counter value, the out-of-order PDCP counter value is associated with an in-order radio link control (RLC) counter value; and controlling the PDCP mode comprises deactivating the PDCP mode for a time duration based at least in part on the detection of the out-of-order PDCP counter value.

In some aspects, monitoring the PDCP counter values comprises monitoring the PDCP counter values at a master cell group (MCG) RLC layer of the UE.

In some aspects, monitoring the PDCP counter values comprises monitoring the PDCP counter values at a secondary cell group (SCG) RLC layer of the UE.

In some aspects, controlling the PDCP mode comprises deactivating the PDCP mode until an end of a connected mode session, or deactivating the PDCP mode for a cell or a public land mobile network (PLMN) based at least in part on the cell or the PLMN experiencing a number of PDCP mode deactivations that satisfies a threshold.

In some aspects, monitoring the PDCP counter values comprises detecting no out-of-order PDCP counter value over a time duration; and controlling the PDCP mode comprises activating the PDCP mode based at least in part on the detection of no out-of-order PDCP counter value over the time duration.

In some aspects, controlling the PDCP mode comprises activating the PDCP mode; and activating the PDCP mode comprises: detecting a gap in which a PDCP packet is not received; determining that a PDCP counter value associated with the gap is less than a serving RLC PDCP counter value at an expiry of a time duration, thereby indicating that the PDCP packet is not expected to be received at the UE; and sending one or more PDCP packets following the gap to an application of the UE without waiting to receive the PDCP packet associated with the gap.

In some aspects, controlling the PDCP mode comprises activating the PDCP mode; and activating the PDCP mode comprises: detecting a gap in which a PDCP packet is not received; determining that a PDCP buffer memory satisfies a threshold; determining, when the PDCP buffer memory satisfies the threshold, that a PDCP counter value associated with the gap is less than a serving RLC PDCP counter value at an expiry of a time duration, thereby indicating that the PDCP packet is not expected to be received at the UE; and sending one or more PDCP packets following the gap to an application of the UE without waiting to receive the PDCP packet associated with the gap.

In some aspects, controlling the PDCP mode comprises activating the PDCP mode from a default setting in which the PDCP mode is deactivated.

In some aspects, controlling the PDCP mode comprises deactivating the PDCP mode from a default setting in which the PDCP mode is activated, wherein the PDCP mode is activated by default for Unacknowledged Mode (UM) bearers.

In some aspects, controlling the PDCP mode comprises deactivating the PDCP mode after a handover of the UE.

In some aspects, controlling the PDCP mode comprises deactivating the PDCP mode after the UE changes from a split bearer associated with dual connectivity to a non-split bearer associated with single connectivity, or changes from a non-split bearer associated with single connectivity to a split bearer associated with dual connectivity.

In some aspects, the PDCP counter values each includes a respective hyper frame number (HFN) and a respective sequence number (SN).

In some aspects, a UE for wireless communication includes a memory and one or more processors, coupled to the memory, configured to: monitor PDCP counter values associated with PDCP packets; and control a PDCP mode of the UE based at least in part on the monitoring of the PDCP counter values.

In some aspects, the PDCP mode enables the UE to deliver, to an application of the UE, one or more PDCP packets without waiting for a time duration to expire, the one or more PDCP packets follow a gap in which a PDCP packet is not expected to be received at the UE.

In some aspects, the one or more processors, to monitor the PDCP counter values, are configured to detect an out-of-order PDCP counter value, the out-of-order PDCP counter value is associated with an in-order RLC counter value; and the one or more processors, to control the PDCP mode, are configured to deactivate the PDCP mode for a time duration based at least in part on the detection of the out-of-order PDCP counter value.

In some aspects, the one or more processors, to monitor the PDCP counter values, are configured to monitor the PDCP counter values at an MCG RLC layer of the UE.

In some aspects, the one or more processors, to monitor the PDCP counter values, are configured to monitor the PDCP counter values at an SCG RLC layer of the UE.

In some aspects, the one or more processors, to control the PDCP mode, are configured to deactivate the PDCP mode until an end of a connected mode session, or deactivate the PDCP mode for a cell or a PLMN based at least in part on the cell or the PLMN experiencing a number of PDCP mode deactivations that satisfies a threshold.

In some aspects, the one or more processors, to monitor the PDCP counter values, are configured to detect no out-of-order PDCP counter value over a time duration; and the one or more processors, to control the PDCP mode, are configured to activate the PDCP mode based at least in part on the detection of no out-of-order PDCP counter value over the time duration.

In some aspects, the one or more processors, to control the PDCP mode, are configured to activate the PDCP mode; and the one or more processors, to activate the PDCP mode, are configured to: detect a gap in which a PDCP packet is not received; determine that a PDCP counter value associated with the gap is less than a serving RLC PDCP counter value at an expiry of a time duration, thereby indicating that the PDCP packet is not expected to be received at the UE; and send one or more PDCP packets following the gap to an application of the UE without waiting to receive the PDCP packet associated with the gap.

In some aspects, the one or more processors, to control the PDCP mode, are configured to activate the PDCP mode; and the one or more processors, to activate the PDCP mode, are configured to: detect a gap in which a PDCP packet is not received; determine that a PDCP buffer memory satisfies a threshold; determine, when the PDCP buffer memory satisfies the threshold, that a PDCP counter value associated with the gap is less than a serving RLC PDCP counter value at an expiry of a time duration, thereby indicating that the PDCP packet is not expected to be received at the UE; and send one or more PDCP packets following the gap to an application of the UE without waiting to receive the PDCP packet associated with the gap.

In some aspects, the one or more processors, to control the PDCP mode, are configured to activate the PDCP mode from a default setting in which the PDCP mode is deactivated.

In some aspects, the one or more processors, to control the PDCP mode, are configured to deactivate the PDCP mode from a default setting in which the PDCP mode is activated, wherein the PDCP mode is activated by default for UM bearers.

In some aspects, the one or more processors, to control the PDCP mode, are configured to deactivate the PDCP mode after a handover of the UE.

In some aspects, the one or more processors, to control the PDCP mode, are configured to deactivate the PDCP mode after the UE changes from a split bearer associated with dual connectivity to a non-split bearer associated with single connectivity, or changes from a non-split bearer associated with single connectivity to a split bearer associated with dual connectivity.

In some aspects, the PDCP counter values each includes a respective HFN and a respective SN.

In some aspects, a non-transitory computer-readable medium storing a set of instructions for wireless communication includes one or more instructions that, when executed by one or more processors of a UE, cause the UE to: monitor PDCP counter values associated with PDCP packets; and control a PDCP mode of the UE based at least in part on the monitoring of the PDCP counter values.

In some aspects, the PDCP mode enables the UE to deliver, to an application of the UE, one or more PDCP packets without waiting for a time duration to expire, the one or more PDCP packets follow a gap in which a PDCP packet is not expected to be received at the UE.

In some aspects, the one or more instructions, that cause the UE to monitor the PDCP counter values, cause the UE to detect an out-of-order PDCP counter value, the out-of-order PDCP counter value is associated with an in-order RLC counter value; and the one or more instructions, that cause the UE to control the PDCP mode, cause the UE to deactivate the PDCP mode for a time duration based at least in part on the detection of the out-of-order PDCP counter value.

In some aspects, the one or more instructions, that cause the UE to monitor the PDCP counter values, cause the UE to monitor the PDCP counter values at an MCG RLC layer of the UE.

In some aspects, the one or more instructions, that cause the UE to monitor the PDCP counter values, cause the UE to monitor the PDCP counter values at an SCG RLC layer of the UE.

In some aspects, the one or more instructions, that cause the UE to control the PDCP mode, cause the UE to deactivate the PDCP mode until an end of a connected mode session, or deactivate the PDCP mode for a cell or a PLMN based at least in part on the cell or the PLMN experiencing a number of PDCP mode deactivations that satisfies a threshold.

In some aspects, the one or more instructions, that cause the UE to monitor the PDCP counter values, cause the UE to detect no out-of-order PDCP counter value over a time duration; and the one or more instructions, that cause the UE to control the PDCP mode, cause the UE to activate the PDCP mode based at least in part on the detection of no out-of-order PDCP counter value over the time duration.

In some aspects, the one or more instructions, that cause the UE to control the PDCP mode, cause the UE to activate the PDCP mode; and the one or more instructions, that cause the UE to activate the PDCP mode, cause the UE to: detect a gap in which a PDCP packet is not received; determine that a PDCP counter value associated with the gap is less than a serving RLC PDCP counter value at an expiry of a time duration, thereby indicating that the PDCP packet is not expected to be received at the UE; and send one or more PDCP packets following the gap to an application of the UE without waiting to receive the PDCP packet associated with the gap.

In some aspects, the one or more instructions, that cause the UE to control the PDCP mode, cause the UE to activate the PDCP mode; and the one or more instructions, that cause the UE to activate the PDCP mode, cause the UE to: detect a gap in which a PDCP packet is not received; determine that a PDCP buffer memory satisfies a threshold; determine, when the PDCP buffer memory satisfies the threshold, that a PDCP counter value associated with the gap is less than a serving RLC PDCP counter value at an expiry of a time duration, thereby indicating that the PDCP packet is not expected to be received at the UE; and send one or more PDCP packets following the gap to an application of the UE without waiting to receive the PDCP packet associated with the gap.

In some aspects, the one or more instructions, that cause the UE to control the PDCP mode, cause the UE to activate the PDCP mode from a default setting in which the PDCP mode is deactivated.

In some aspects, the one or more instructions, that cause the UE to control the PDCP mode, cause the UE to deactivate the PDCP mode from a default setting in which the PDCP mode is activated, wherein the PDCP mode is activated by default for UM bearers.

In some aspects, the one or more instructions, that cause the UE to control the PDCP mode, cause the UE to deactivate the PDCP mode after a handover of the UE.

In some aspects, the one or more instructions, that cause the UE to control the PDCP mode, cause the UE to deactivate the PDCP mode after the UE changes from a split bearer associated with dual connectivity to a non-split bearer associated with single connectivity, or changes from a non-split bearer associated with single connectivity to a split bearer associated with dual connectivity.

In some aspects, the PDCP counter values each includes a respective HFN and a respective SN.

In some aspects, an apparatus for wireless communication includes means for monitoring PDCP counter values associated with PDCP packets; and means for controlling a PDCP mode of the apparatus based at least in part on the monitoring of the PDCP counter values.

In some aspects, the PDCP mode enables the apparatus to deliver, to an application of the apparatus, one or more PDCP packets without waiting for a time duration to expire, the one or more PDCP packets follow a gap in which a PDCP packet is not expected to be received at the apparatus.

In some aspects, the means for monitoring the PDCP counter values comprises means for detecting an out-of-order PDCP counter value, the out-of-order PDCP counter value is associated with an in-order RLC counter value; and the means for controlling the PDCP mode comprises means for deactivating the PDCP mode for a time duration based at least in part on the detection of the out-of-order PDCP counter value.

In some aspects, the means for monitoring the PDCP counter values comprises means for monitoring the PDCP counter values at an MCG RLC layer of the apparatus.

In some aspects, the means for monitoring the PDCP counter values comprises means for monitoring the PDCP counter values at an SCG RLC layer of the apparatus.

In some aspects, the means for controlling the PDCP mode comprises means for deactivating the PDCP mode until an end of a connected mode session, or means for deactivating the PDCP mode for a cell or a PLMN based at least in part on the cell or the PLMN experiencing a number of PDCP mode deactivations that satisfies a threshold.

In some aspects, the means for monitoring the PDCP counter values comprises means for detecting no out-of-order PDCP counter value over a time duration; and the means for controlling the PDCP mode comprises means for activating the PDCP mode based at least in part on the detection of no out-of-order PDCP counter value over the time duration.

In some aspects, the means for controlling the PDCP mode comprises means for activating the PDCP mode; and the means for activating the PDCP mode comprises: means for detecting a gap in which a PDCP packet is not received; means for determining that a PDCP counter value associated with the gap is less than a serving RLC PDCP counter value at an expiry of a time duration, thereby indicating that the PDCP packet is not expected to be received at the apparatus; and means for sending one or more PDCP packets following the gap to an application of the apparatus without waiting to receive the PDCP packet associated with the gap.

In some aspects, the means for controlling the PDCP mode comprises means for activating the PDCP mode; and the means for activating the PDCP mode comprises: means for detecting a gap in which a PDCP packet is not received; means for determining that a PDCP buffer memory satisfies a threshold; means for determining, when the PDCP buffer memory satisfies the threshold, that a PDCP counter value associated with the gap is less than a serving RLC PDCP counter value at an expiry of a time duration, thereby indicating that the PDCP packet is not expected to be received at the apparatus; and means for sending one or more PDCP packets following the gap to an application of the apparatus without waiting to receive the PDCP packet associated with the gap.

In some aspects, the means for controlling the PDCP mode comprises means for activating the PDCP mode from a default setting in which the PDCP mode is deactivated.

In some aspects, the means for controlling the PDCP mode comprises means for deactivating the PDCP mode from a default setting in which the PDCP mode is activated, wherein the PDCP mode is activated by default for UM bearers.

In some aspects, the means for controlling the PDCP mode comprises means for deactivating the PDCP mode after a handover of the apparatus.

In some aspects, the means for controlling the PDCP mode comprises means for deactivating the PDCP mode after the apparatus changes from a split bearer associated with dual connectivity to a non-split bearer associated with single connectivity, or changes from a non-split bearer associated with single connectivity to a split bearer associated with dual connectivity.

In some aspects, the PDCP counter values each includes a respective HFN and a respective SN.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3-4 are diagrams illustrating examples of radio protocol architectures, in accordance with the present disclosure.

FIGS. 5-6 are diagrams illustrating examples of out-of-order PDCP counter values and corresponding in-order RLC counter values, in accordance with the present disclosure.

FIGS. 7-9 are diagrams illustrating examples associated with controlling a PDCP mode at a UE, in accordance with the present disclosure.

FIG. 10 is a diagram illustrating an example process associated with controlling a PDCP mode at a UE, in accordance with the present disclosure.

FIGS. 11-12 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

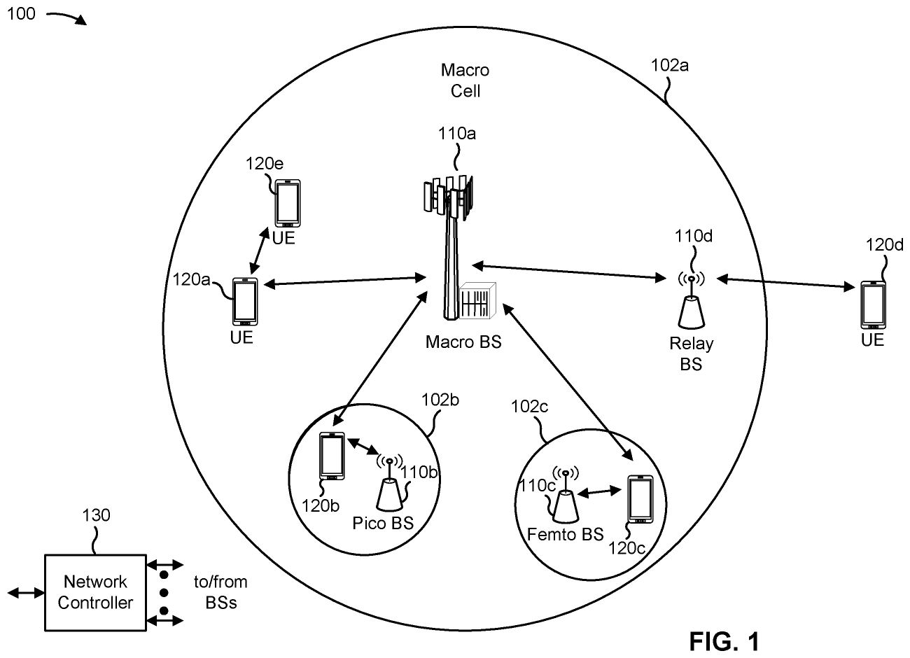

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

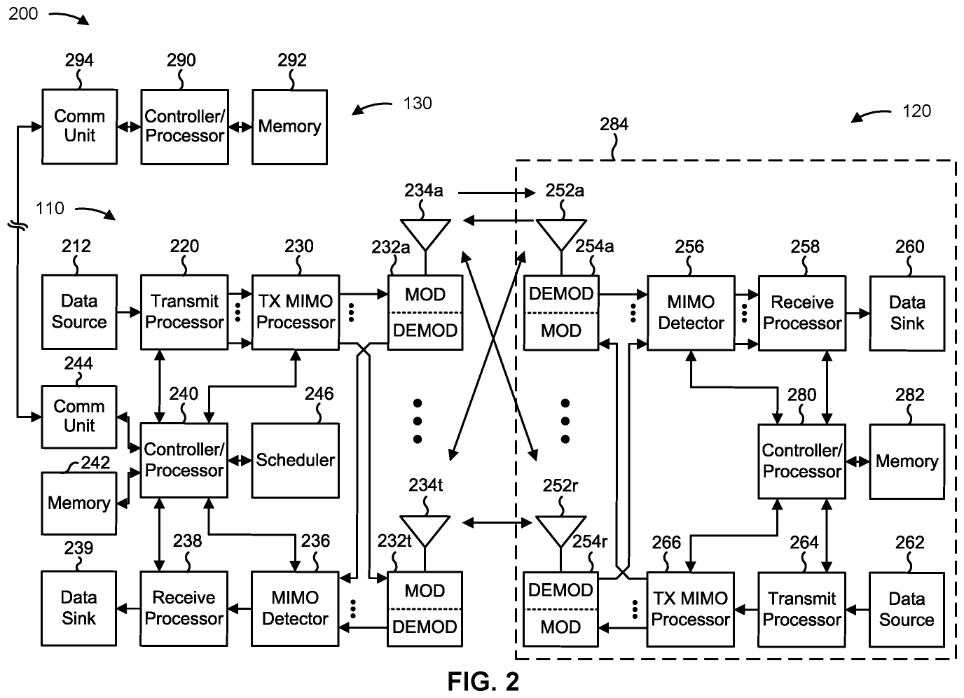

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T>1). The UE 120 may be equipped with a set of antennas 252a through 252r, such as R antennas (R>1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

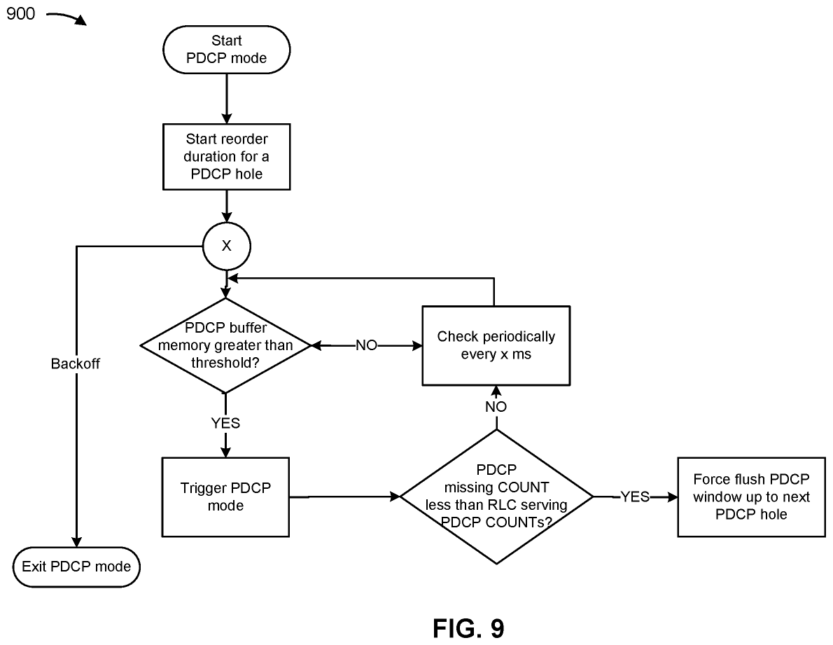

The controller/processor 240 of the base station 110, the controller/processor 280 of the UE 120, and/or any other component(s) of FIG. 2 may perform one or more techniques associated with controlling a packet data convergence protocol mode at a user equipment, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, and/or other processes as described herein. In some examples, executing instructions may include running the instructions, converting the instructions, compiling the instructions, and/or interpreting the instructions, among other examples.

In some aspects, a UE (e.g., UE 120) may include means for monitoring packet data convergence protocol (PDCP) counter values associated with PDCP packets, and/or means for controlling a PDCP mode of the UE based at least in part on the monitoring of the PDCP counter values. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, and/or receive processor 258.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

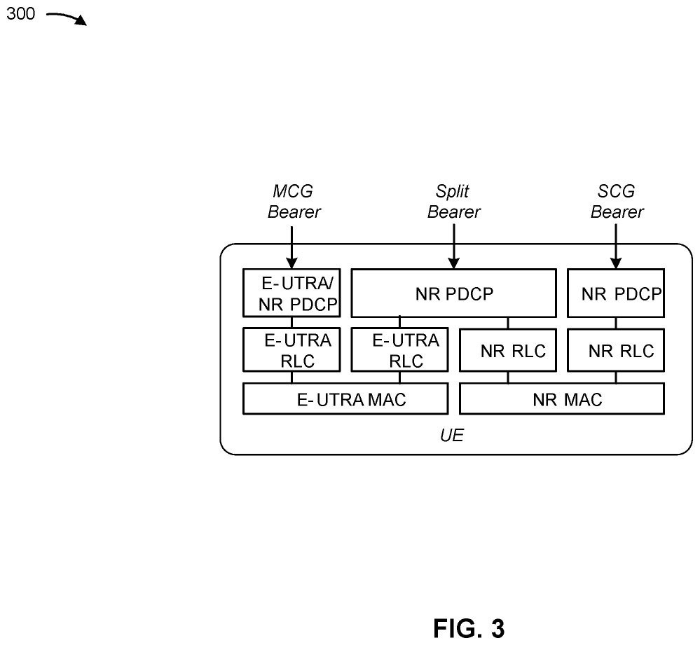

FIG. 3 is a diagram illustrating an example 300 of a radio protocol architecture, in accordance with the present disclosure.

As shown in FIG. 3, a radio protocol architecture for master cell group (MCG), secondary cell group (SCG), and split bearers may be defined for a UE in Multi-Radio Dual Connectivity (MR-DC) with E-UTRA-NR Dual Connectivity (EN-DC). The split bearer may be associated with an NR PDCP layer, an E-UTRA radio link control (RLC) layer, and an NR RLC layer. In other words, the NR PDCP layer may communicate with the E-UTRA RLC layer and the NR RLC layer.

As indicated above, FIG. 3 is provided as an example. Other examples may differ from what is described with regard to FIG. 3.

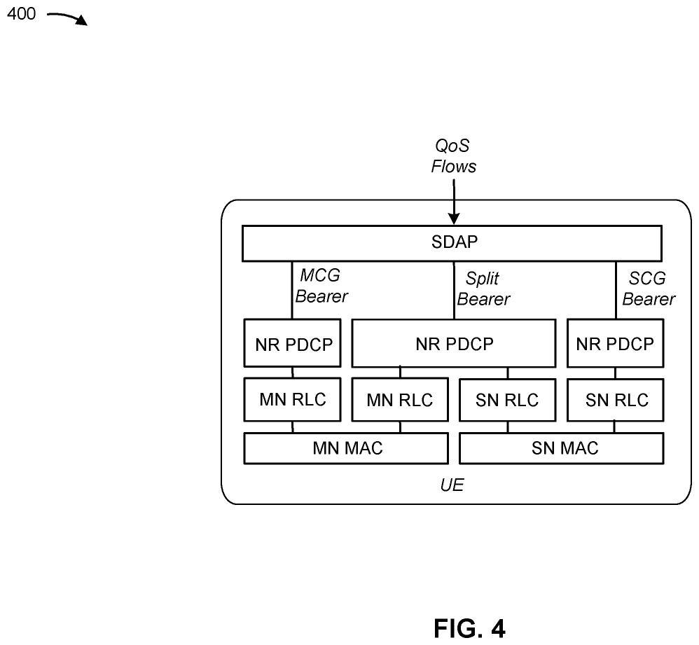

FIG. 4 is a diagram illustrating an example 400 of a radio protocol architecture, in accordance with the present disclosure.

As shown in FIG. 4, a radio protocol architecture for MCG, SCG and split bearers may be defined for a UE in MR-DC with NG-RAN E-UTRA-NR Dual Connectivity (NGEN-DC), NR-E-UTRA Dual Connectivity (NGEN-DC), and NR-NR Dual Connectivity (NR-DC). The split bearer may be associated with an NR PDCP layer, a master node (MN) RLC layer, and a secondary node (SN) RLC layer. In other words, the NR PDCP layer may communicate with the MN RLC layer and the SN RLC layer.

As indicated above, FIG. 4 is provided as an example. Other examples may differ from what is described with regard to FIG. 4.

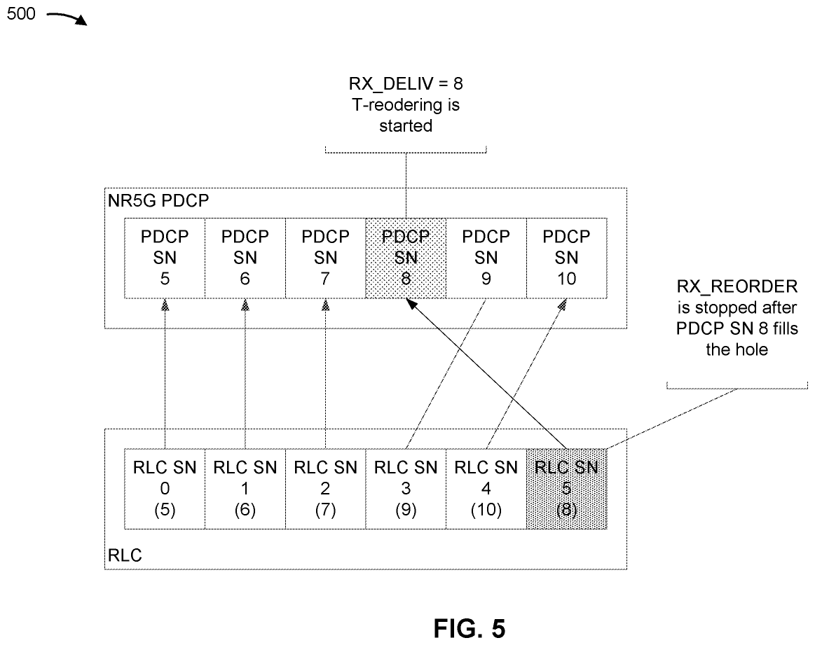

FIG. 5 is a diagram illustrating an example 500 of out-of-order PDCP counter values and corresponding in-order RLC counter values, in accordance with the present disclosure.

As shown in FIG. 5, a PDCP layer of a UE may receive PDCP counter values (COUNTs) from an RLC layer of the UE. The PDCP COUNTs may be associated with PDCP packets, such as PDCP data protocol data units (PDUs). The PDCP COUNTs may be received using RLC COUNTs from the RLC layer. The PDCP COUNTs at the PDCP layer may be received out-of-order, but the corresponding RLC COUNTs at the RLC layer may be in-order.

The in-order RLC COUNTs may include a first RLC COUNT with an SN of 0, a second RLC COUNT with an SN of 1, a third RLC COUNT with an SN of 2, a fourth RLC COUNT with an SN of 3, a fifth RLC COUNT with an SN of 4, and a sixth RLC COUNT with an SN of 5. The first RLC COUNT may correspond to a first PDCP COUNT with an SN of 5, the second RLC COUNT may correspond to a second PDCP COUNT with an SN of 6, and the third RLC COUNT may correspond to a third PDCP COUNT with an SN of 7. The first, second, and third PDCP COUNTs corresponding to SNs of 5, 6, and 7, respectively, may be transmitted to the PDCP layer in-order.

A fourth PDCP COUNT with an SN of 8 may initially not be received at the PDCP layer. A PDCP hole (or gap) may occur when the fourth PDCP COUNT is not received at the PDCP layer. The PDCP hole may be associated with a PDCP packet (e.g., a fourth PDCP packet corresponding to the fourth PDCP COUNT) that has not been received at the PDCP layer. In other words, the PDCP hole may correspond to a gap in which the fourth PDCP COUNT is not received at the PDCP layer.

The fourth RLC COUNT may correspond to a fifth PDCP COUNT with an SN of 9, and the fifth RLC COUNT may correspond to a sixth PDCP COUNT with an SN of 10. The fifth and sixth PDCP COUNTs corresponding to SNs of 9 and 10, respectively, may be transmitted to the PDCP layer out-of-order. In other words, the fifth and sixth PDCP COUNTs may be received at the PDCP layer before the fourth PDCP COUNT with the SN of 8 is received at the PDCP layer.

The sixth RLC COUNT may correspond to the fourth PDCP COUNT with the SN of 8. The fourth PDCP COUNT corresponding to the SN of 8 may be transmitted to the PDCP layer to fill the PDCP hole initially created when the fourth PDCP COUNT corresponding to the SN of 8 was not received immediately after the first, second, and third PDCP COUNTs corresponding to SNs of 5, 6, and 7, respectively, were received at the PDCP layer.

A time duration may be started when the PDCP hole is detected at the PDCP layer. In other words, the time duration may be started when the fourth PDCP COUNT corresponding to the SN of 8 is not received in-order, thereby creating the PDCP hole. The time duration may be stopped when the fourth PDCP COUNT corresponding to the SN of 8 is received to fill the PDCP hole.

As indicated above, FIG. 5 is provided as an example. Other examples may differ from what is described with regard to FIG. 5.

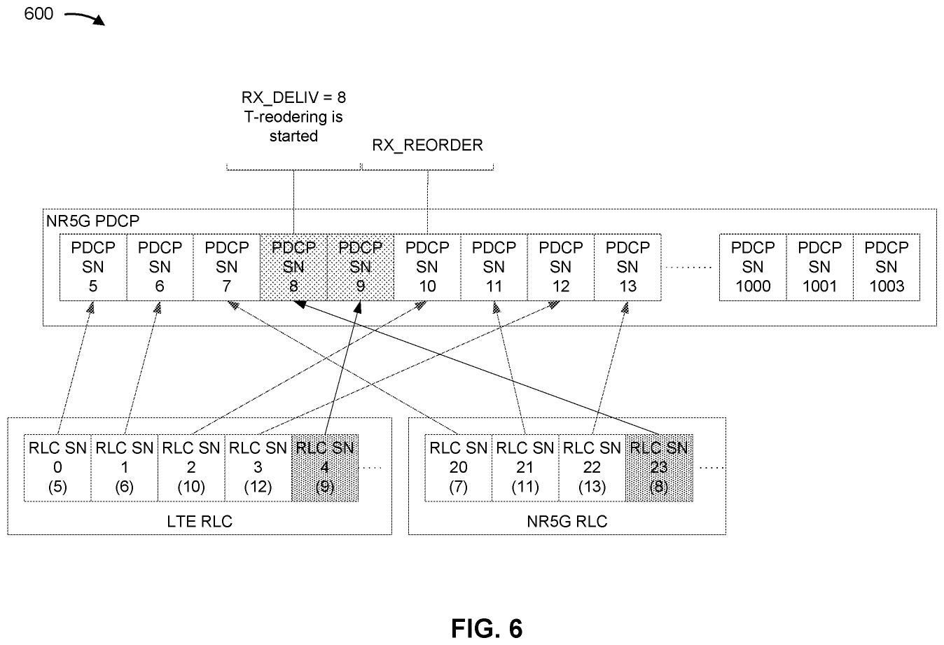

FIG. 6 is a diagram illustrating an example 600 of out-of-order PDCP COUNTs and corresponding in-order RLC COUNTs, in accordance with the present disclosure.

As shown in FIG. 6, a PDCP layer of a UE may receive PDCP COUNTs from multiple RLC layers of the UE. The PDCP COUNTs may be associated with PDCP packets, such as PDCP data PDUs. The multiple RLC layers may include an E-UTRA RLC layer and an NR RLC layer when the UE is configured for dual connectivity. The PDCP COUNTs may be received using RLC COUNTs from the multiple RLC layers. The PDCP COUNTs at the PDCP layer may be received out-of-order, but the corresponding RLC COUNTs at the multiple RLC layers may be in-order.

A fourth PDCP COUNT with an SN of 8 and a fifth PDCP COUNT with an SN of 9 may initially not be received at the PDCP layer. PDCP holes may initially occur when the fourth and fifth PDCP COUNTs are not received at the PDCP layer. The fourth PDCP COUNT with the SN of 8 and the fifth PDCP COUNT with the SN of 9 may later be received at the PDCP layer from the E-UTRA RLC layer and the NR RLC layer, respectively, which may fill the PDCP holes at the PDCP layer. A time duration, which may have been started when the PDCP holes were detected at the PDCP layer, may be stopped when the fourth and fifth PDCP COUNTs corresponding to the SNs of 8 and 9, respectively, are received to fill the PDCP holes.

As indicated above, FIG. 6 is provided as an example. Other examples may differ from what is described with regard to FIG. 6.

A network (e.g., a base station) may transmit PDCP COUNTs to a UE. The PDCP COUNTs may be associated with PDCP data PDUs that are transmitted to the UE. A PDCP COUNT may be a 32-bit number that includes an HFN and an SN. The PDCP COUNT may be a value that is incremented for each PDCP data PDU during a radio resource control (RRC) connection between the network and the UE. The PDCP COUNTs (associated with the PDCP data PDUs) may be transmitted in-order to the UE. In some cases, PDCP COUNTs may be lost during transmission, and the PDCP COUNTs that were lost may be retransmitted to the UE. As a result, the retransmitted PDCP COUNTs may be received out-of-order to the UE. The retransmitted PDCP COUNTs may be received following a higher PDCP COUNT, so the retransmitted PDCP COUNTs may be considered to be out-of-order. The retransmitted PDCP COUNTs may be received out-of-order at the UE, but carrying RLC COUNTs at the UE may be in-order. In other words, the RLC COUNTs may correspond to the retransmitted PDCP COUNTs, but the RLC COUNTs may be in-order, whereas the retransmitted PDCP COUNTs may be out-of-order.

In some cases, PDCP COUNTs that are lost in the network may not be retransmitted to the UE. However, the UE may wait for a time duration to receive the lost PDCP COUNTs (and corresponding PDCP packets) from the network. The UE may only determine that the lost PDCP COUNTs are not likely to be received from the network after the time duration expires. While the UE is waiting for the lost PDCP COUNTs, the UE may not send subsequent PDCP packets that have been received from the network to an application running at the UE. As a result, lost PDCP COUNTs may increase an overall latency and decrease performance of the application running at the UE.

In some cases, the UE may not wait for the time duration to expire to send subsequent PDCP packets that have been received from the network to the application running at the UE. In other words, the UE may not have received a lost PDCP COUNT (and corresponding PDCP packet), but the UE may send the subsequent PDCP packets to the application. The UE may send the subsequent PDCP packets when the network is detected to be sending out-of-order PDCP COUNTs, which may increase a likelihood that the lost PDCP COUNT will be received at the UE within the time duration. If the lost PDCP COUNT is later received at the UE, the lost PDCP COUNT cannot be sent to the application because the subsequent PDCP packets have already been sent to the application, thereby resulting in loss of data for the application.

In various aspects of techniques and apparatuses described herein, a PDCP mode (e.g., a PDCP “force flush” mode) may be dynamically controlled by the UE. The UE may control the PDCP mode based at least in part on a monitoring of PDCP COUNTs received at the UE, where the PDCP COUNTs may be associated with PDCP data PDUs received at the UE. In some aspects, when out-of-order PDCP COUNTs are detected at the UE, the PDCP mode may be deactivated at the UE. In some aspects, when out-of-order PDCP COUNTs are not detected at the UE, the PDCP mode may be activated at the UE. When the PDCP mode is activated at the UE, the UE may transmit one or more PDCP packets following a PDCP hole to an application of the UE without waiting for a time duration to expire. The one or more PDCP packets may be transmitted when a lost PDCP packet associated with the PDCP hole is not expected to be received at the UE. The PDCP mode may be considered as a “force flush” mode because the one or more PDCP packets may be “force flushed” or transmitted to the application without waiting for the time duration to expire, and/or without waiting for the lost PDCP packet associated with the PDCP hole to be received.

In some aspects, when the out-of-order PDCP COUNTs are detected at the UE, the UE may benefit from deactivating the PDCP mode because lost PDCP packets are more likely to be received at the UE later in time. Since the lost PDCP packets are more likely to be received, the UE may undergo increased data loss by transmitting later-received PDCP packets without waiting for the lost PDCP packets to be received. On the other hand, when no out-of-order PDCP COUNTs are detected at the UE, the UE may benefit from activating the PDCP mode, which may enable the UE to transmit later-received PDCP packets without waiting for the time duration to expire when the lost PDCP packets are unlikely to be received at the UE.

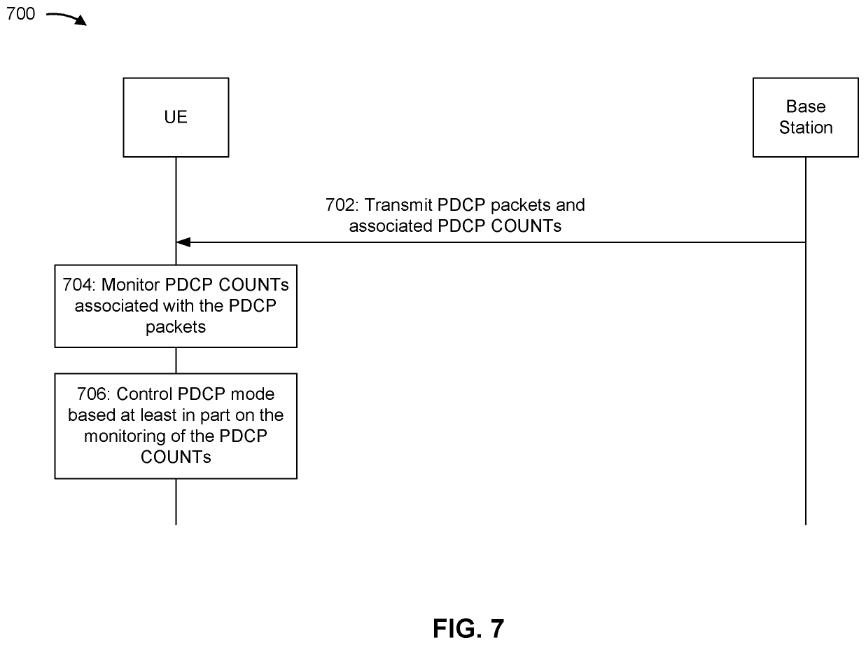

FIG. 7 is a diagram illustrating an example 700 of controlling a PDCP mode at a UE, in accordance with the present disclosure. As shown in FIG. 7, example 700 includes communication between a UE (e.g., UE 120a) and a base station (e.g., base station 110a). In some aspects, the UE and the base station may be included in a wireless network such as wireless network 100. The UE and the base station may communicate on a wireless sidelink.

As shown by reference number 702, the base station may transmit PDCP packets to the UE. The PDCP packets transmitted to the UE may be a first transmission or a retransmission of previously transmitted PDCP packets. The PDCP packets may be associated with PDCP COUNTs (counter values). The PDCP COUNTs may each include a respective HFN and a respective SN.

As shown by reference number 704, the UE may monitor the PDCP COUNTs associated with the PDCP packets received at the UE. For example, the UE may monitor for out-of-order PDCP COUNTs. The UE may monitor the PDCP COUNTs at an MCG RLC layer of the UE, and/or the UE may monitor the PDCP COUNTs at an SCG RLC layer of the UE.

As shown by reference number 706, the UE may control a PDCP mode based at least in part on the monitoring of the PDCP COUNTs. The PDCP mode, which may be referred to as a PDCP force flush mode, may enable the UE to transmit, to an application of the UE, one or more PDCP packets without waiting for a time duration to expire. The one or more PDCP packets may follow a PDCP hole (or gap) in which a PDCP packet is not expected to be received at the UE.

In some aspects, the UE may control the PDCP mode by activating the PDCP mode from a default setting in which the PDCP mode is deactivated. In some aspects, the UE may control the PDCP mode by deactivating the PDCP mode from a default setting in which the PDCP mode is activated. The PDCP mode may be activated by default for UM bearers.

In some aspects, the UE may control the PDCP mode by deactivating the PDCP mode after a handover of the UE. For example, the PDCP mode may be deactivated after the UE is handed over from a first base station to a second base station. In some aspects, the UE may control the PDCP mode by deactivating the PDCP mode until an end of a connected mode session, or the UE may control the PDCP mode by deactivating the PDCP mode for a cell or a public land mobile network (PLMN) based at least in part on the cell or the PLMN experiencing a number of PDCP mode deactivations that satisfies a threshold.

In some aspects, the UE may control the PDCP mode by deactivating the PDCP mode after the UE changes from a split bearer associated with dual connectivity to a non-split bearer associated with single connectivity. In some aspects, the UE may control the PDCP mode by deactivating the PDCP mode after the UE changes from a non-split bearer associated with single connectivity to a split bearer associated with dual connectivity.

In some aspects, when monitoring the PDCP COUNTs, the UE may detect an out-of-order PDCP COUNT. The out-of-order PDCP COUNT may be associated with an in-order RLC COUNT. When controlling the PDCP mode, the UE may deactivate the PDCP mode for a time duration based at least in part on the detection of the out-of-order PDCP COUNT.

In some aspects, when monitoring the PDCP COUNTs, the UE may detect no out-of-order PDCP COUNT over a time duration. When controlling the PDCP mode, the UE may activate the PDCP mode based at least in part on the detection of no out-of-order PDCP COUNT over the time duration.

In some aspects, when controlling the PDCP mode, the UE may activate the PDCP mode. During activation of the PDCP mode, the UE may detect a PDCP hole (or gap) in which a PDCP packet is not received. The UE may determine that a PDCP COUNT associated with the PDCP hole is less than an RLC serving PDCP COUNT at an expiry of a time duration, thereby indicating that the PDCP packet is not expected to be received at the UE. The UE may send one or more PDCP packets following the PDCP hole to an application of the UE without waiting to receive the PDCP packet associated with the PDCP hole. In some aspects, RX DELIV may refer to a first COUNT that is missing at a PDCP layer of the UE. An RLC layer (e.g., MCG RLC layer or SCG RLC layer) may track which PDCP COUNTs have been submitted. A last submitted PDCP count+1 may be considered to be the RLC serving PDCP COUNT and may be associated with an RLC RX NEXT. When the RX DELIV is less than the COUNT associated with the RLC RX NEXT (in case of NR) or VR(R) in case of LTE, then the UE may determine that the PDCP COUNT associated with the PDCP hole is less than the RLC serving PDCP COUNT.

In some aspects, when controlling the PDCP mode, the UE may activate the PDCP mode. During activation of the PDCP mode, the UE may detect a PDCP hole (or gap) in which a PDCP packet is not received. The UE may determine that a PDCP buffer memory satisfies a threshold. For example, the UE may determine that the PDCP buffer memory has reached a defined capacity. The UE may determine, when the PDCP buffer memory satisfies the threshold, that a PDCP COUNT associated with the PDCP hole is less than a serving RLC PDCP COUNT at an expiry of a time duration, thereby indicating that the PDCP packet is not expected to be received at the UE. The UE may send one or more PDCP packets following the PDCP hole to an application of the UE without waiting to receive the PDCP packet associated with the PDCP hole.

As indicated above, FIG. 7 is provided as an example. Other examples may differ from what is described with regard to FIG. 7.

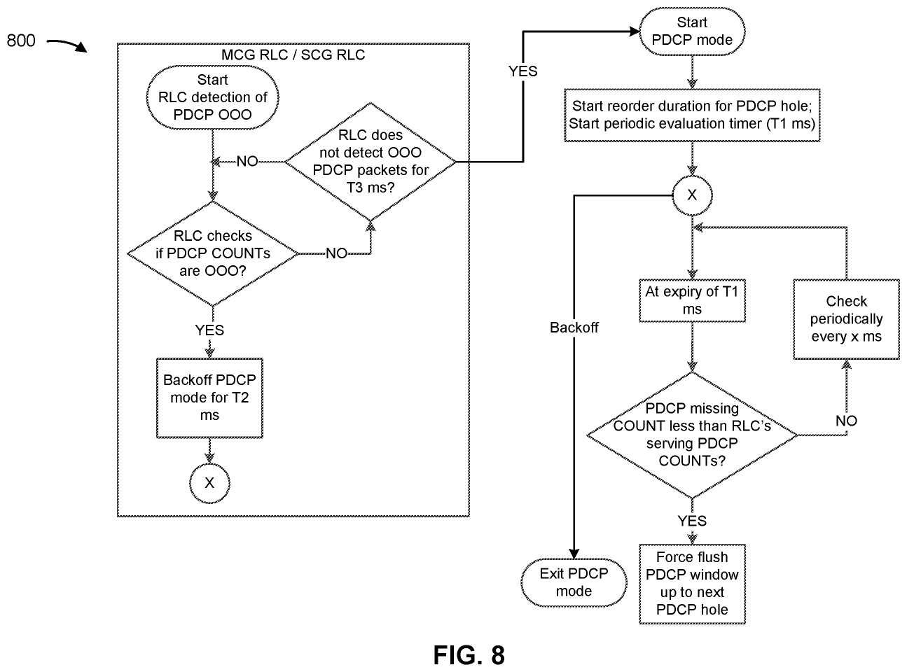

FIG. 8 is a diagram illustrating an example 800 of controlling a PDCP mode at a UE, in accordance with the present disclosure.

As shown in FIG. 8, a UE may include an MCG RLC layer and an SCG RLC layer when the UE includes a split bearer for dual connectivity. The MCG RLC layer and/or the SCG RLC layer may start an RLC detection of out-of-order (000) PDCP COUNTs. The MCG RLC layer and/or the SCG RLC layer may determine if PDCP COUNTs are received out-of-order. When a determination is made that the PDCP COUNTs are received out-of-order, the MCG RLC layer and/or the SCG RLC layer may backoff a PDCP force flush optimization for a time duration of T2. In other words, when the determination is made that the PDCP COUNTs are received out-of-order, the MCG RLC layer and/or the SCG RLC layer may deactivate the PDCP mode for the time duration of T2.

As shown in FIG. 8, when a determination is made that the PDCP COUNTs are not received out-of-order, the MCG RLC layer and/or the SCG RLC layer may determine whether out-of-order PDCP COUNTs (and corresponding PDCP data PDUs) are not detected for a time duration of T3. When out-of-order PDCP COUNTs (and corresponding PDCP data PDUs) are detected for the time duration of T3 (e.g., the condition is not met), the MCG RLC layer and/or the SCG RLC layer may again determine if PDCP COUNTs are received out-of-order.

As shown in FIG. 8, when out-of-order PDCP COUNTs (and corresponding PDCP data PDUs) are not detected for the time duration of T3 (e.g., the condition is met), the MCG RLC layer and/or the SCG RLC layer may activate the PDCP mode.

As shown in FIG. 8, when the PDCP mode is activated, a PDCP hole may be detected at a PDCP layer of the UE. The PDCP hole may correspond to a PDCP packet that has not been received at the UE. When the PDCP hole is detected, an evaluation timer of T1 may be started and a packet reordering duration may be started. At an expiry of the evaluation timer, the PDCP layer may determine whether a PDCP COUNT associated with the PDCP hole is less than a serving RLC PDCP COUNT. When the PDCP COUNT associated with the PDCP hole is not less than the serving RLC PDCP COUNT, the PDCP layer may periodically redetermine if the PDCP COUNT associated with the PDCP hole is less than the serving RLC PDCP COUNT. When the PDCP COUNT associated with the PDCP hole is determined to be less than the serving RLC PDCP COUNT, the PDCP layer may force flush a PDCP window up to a subsequent PDCP hole. In other words, the PDCP layer may transmit one or more PDCP packets received after the PDCP hole to an application of the UE, without waiting for the packet reordering duration to expire, and/or without waiting for the PDCP packet associated with the PDCP hole to be received at the UE.

In some aspects, the UE may continuously monitor whether out-of-order PDCP COUNTs are received at RLC entities associated with PDCP entities. In some cases, the PDCP mode may be active as a default setting. The PDCP mode may be deactivated after an out-of-order PDCP COUNT detection. The deactivation of the PDCP mode may occur for a time duration, after which the PDCP mode may become active again. Alternatively, the deactivation of the PDCP mode may occur until an end of a connected mode session. Alternatively, the deactivation of the PDCP mode may correspond to a cell or a PLMN when the cell or the PLMN has experienced a number of PDCP mode deactivations that satisfies a threshold.

In some cases, the PDCP mode may be inactive as a default setting. After a time duration of no out-of-order PDCP COUNT detection, the PDCP mode may be activated.

As indicated above, FIG. 8 is provided as an example. Other examples may differ from what is described with regard to FIG. 8.

FIG. 9 is a diagram illustrating an example 900 of controlling a PDCP mode at a UE, in accordance with the present disclosure.

As shown in FIG. 9, when the PDCP mode is activated, a PDCP hole may be detected at a PDCP layer of the UE. The PDCP hole may correspond to a PDCP packet that has not been received at the UE. When the PDCP hole is detected, a packet reordering duration may be started. The PDCP layer may determine whether a PDCP buffer memory satisfies a threshold. When the PDCP buffer memory does not satisfy the threshold, the PDCP layer may periodically redetermine whether the PDCP buffer memory satisfies the threshold. When the PDCP buffer memory satisfies the threshold, the PDCP layer may determine whether a PDCP COUNT associated with the PDCP hole is less than a serving RLC PDCP COUNT. When the PDCP COUNT associated with the PDCP hole is not less than the serving RLC PDCP COUNT, the PDCP layer may periodically redetermine if the PDCP PDCP COUNT associated with the PDCP hole is less than the serving RLC PDCP COUNT. When the PDCP COUNT associated with the PDCP hole is determined to be less than the serving RLC COUNT, the PDCP layer may force flush a PDCP window up to a subsequent PDCP hole. In other words, the PDCP layer may transmit one or more PDCP packets received after the PDCP hole to an application of the UE, without waiting for the packet reordering duration to expire, and/or without waiting for the PDCP packet associated with the PDCP hole to be received at the UE.

In the example shown in FIG. 9, the PDCP mode may be activated when the PDCP buffer memory satisfies the threshold. For example, the PDCP mode may be activated when a PDCP reordering buffer occupancy exceeds a memory limit threshold.

As indicated above, FIG. 9 is provided as an example. Other examples may differ from what is described with regard to FIG. 9.

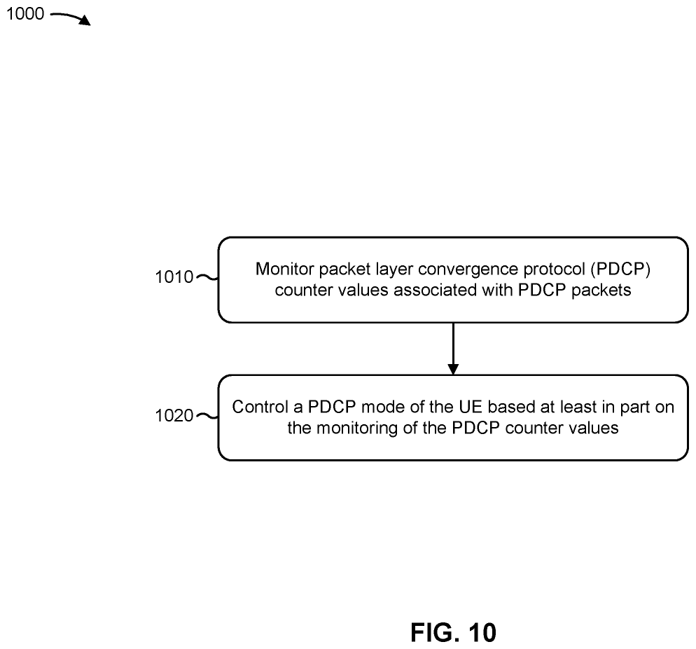

FIG. 10 is a diagram illustrating an example process 1000 performed, for example, by a user equipment (UE), in accordance with the present disclosure. Example process 1000 is an example where the UE (e.g., UE 120) performs operations associated with techniques for controlling a packet data convergence protocol mode at a user equipment.

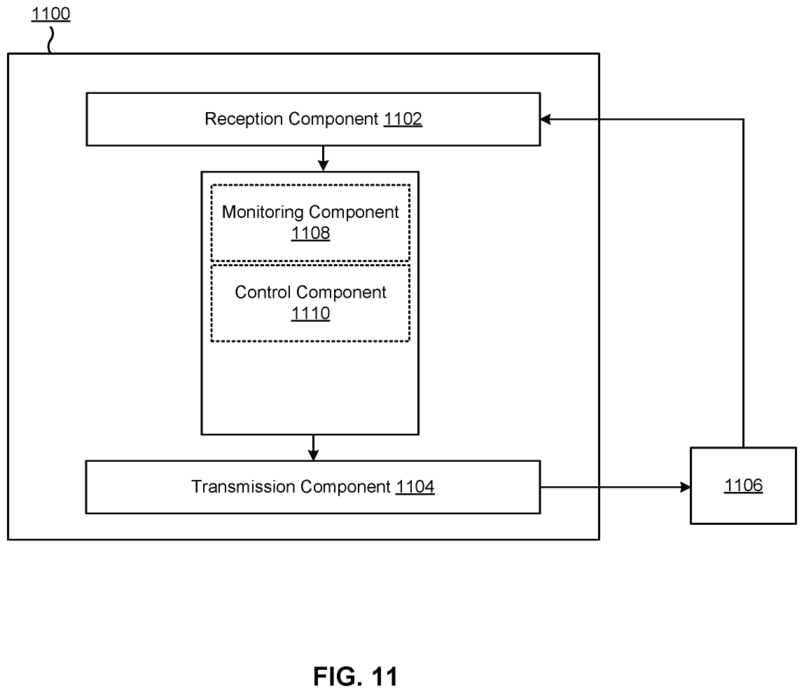

As shown in FIG. 10, in some aspects, process 1000 may include monitoring packet data convergence protocol (PDCP) counter values associated with PDCP packets (block 1010). For example, the UE (e.g., using monitoring component 1108, depicted in FIG. 11) may monitoring packet data convergence protocol (PDCP) counter values associated with PDCP packets, as described above.

As further shown in FIG. 10, in some aspects, process 1000 may include controlling a PDCP mode of the UE based at least in part on the monitoring of the PDCP counter values (block 1020). For example, the UE (e.g., using control component 1110, depicted in FIG. 11) may control a PDCP mode of the UE based at least in part on the monitoring of the PDCP counter values, as described above.

Process 1000 may include additional aspects, such as any single aspect or any combination of aspects described below and/or in connection with one or more other processes described elsewhere herein.

In a first aspect, the PDCP mode enables the UE to deliver, to an application of the UE, one or more PDCP packets without waiting for a time duration to expire, wherein the one or more PDCP packets follow a gap in which a PDCP packet is not expected to be received at the UE.

In a second aspect, alone or in combination with the first aspect, monitoring the PDCP counter values comprises detecting an out-of-order PDCP counter value, wherein the out-of-order PDCP counter value is associated with an in-order radio link control (RLC) counter value, and controlling the PDCP mode comprises deactivating the PDCP mode for a time duration based at least in part on the detection of the out-of-order PDCP counter value.

In a third aspect, alone or in combination with one or more of the first and second aspects, monitoring the PDCP counter values comprises monitoring the PDCP counter values at a master cell group (MCG) radio link control (RLC) layer of the UE.

In a fourth aspect, alone or in combination with one or more of the first through third aspects, monitoring the PDCP counter values comprises monitoring the PDCP counter values at a secondary cell group (SCG) radio link control (RLC) layer of the UE.

In a fifth aspect, alone or in combination with one or more of the first through fourth aspects, controlling the PDCP mode comprises deactivating the PDCP mode until an end of a connected mode session, or deactivating the PDCP mode for a cell or a PLMN based at least in part on the cell or the PLMN experiencing a number of PDCP mode deactivations that satisfies a threshold.

In a sixth aspect, alone or in combination with one or more of the first through fifth aspects, monitoring the PDCP counter values comprises detecting no out-of-order PDCP counter value over a time duration, and controlling the PDCP mode comprises activating the PDCP mode based at least in part on the detection of no out-of-order PDCP counter value over the time duration.

In a seventh aspect, alone or in combination with one or more of the first through sixth aspects, controlling the PDCP mode comprises activating the PDCP mode, and activating the PDCP mode comprises detecting a gap in which a PDCP packet is not received, determining that a PDCP counter value associated with the gap is less than a serving RLC PDCP counter value at an expiry of a time duration, thereby indicating that the PDCP packet is not expected to be received at the UE, and sending one or more PDCP packets following the gap to an application of the UE without waiting to receive the PDCP packet associated with the gap.

In an eighth aspect, alone or in combination with one or more of the first through seventh aspects, controlling the PDCP mode comprises activating the PDCP mode, and activating the PDCP mode comprises detecting a gap in which a PDCP packet is not received, determining that a PDCP buffer memory satisfies a threshold, determining, when the PDCP buffer memory satisfies the threshold, that a PDCP counter value associated with the gap is less than a serving RLC PDCP counter value at an expiry of a time duration, thereby indicating that the PDCP packet is not expected to be received at the UE, and sending one or more PDCP packets following the gap to an application of the UE without waiting to receive the PDCP packet associated with the gap.

In a ninth aspect, alone or in combination with one or more of the first through eighth aspects, controlling the PDCP mode comprises activating the PDCP mode from a default setting in which the PDCP mode is deactivated.

In a tenth aspect, alone or in combination with one or more of the first through ninth aspects, controlling the PDCP mode comprises deactivating the PDCP mode from a default setting in which the PDCP mode is activated, wherein the PDCP mode is activated by default for UM bearers.

In an eleventh aspect, alone or in combination with one or more of the first through tenth aspects, controlling the PDCP mode comprises deactivating the PDCP mode after a handover of the UE.

In a twelfth aspect, alone or in combination with one or more of the first through eleventh aspects, controlling the PDCP mode comprises deactivating the PDCP mode after the UE changes from a split bearer associated with dual connectivity to a non-split bearer associated with single connectivity, or changes from a non-split bearer associated with single connectivity to a split bearer associated with dual connectivity.

In a thirteenth aspect, alone or in combination with one or more of the first through twelfth aspects, the PDCP counter values each includes a respective hyper frame number (HFN) and a respective sequence number (SN).

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a block diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include one or more of a monitoring component 1108, or a control component 1110, among other examples.

In some aspects, the apparatus 1100 may be configured to perform one or more operations described herein in connection with FIGS. 7-9. Additionally or alternatively, the apparatus 1100 may be configured to perform one or more processes described herein, such as process 1000 of FIG. 10 In some aspects, the apparatus 1100 and/or one or more components shown in FIG. 11 may include one or more components of the UE described above in connection with FIG. 2. Additionally, or alternatively, one or more components shown in FIG. 11 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the UE described above in connection with FIG. 2. In some aspects, the transmission component 1104 may be co-located with the reception component 1102 in a transceiver.

The monitoring component 1108 may monitor PDCP counter values associated with PDCP packets. The monitoring component 1108 may detect an out-of-order PDCP counter value, wherein the out-of-order PDCP counter value is associated with an in-order RLC counter value. The monitoring component 1108 may monitor the PDCP counter values at an MCG RLC layer of the UE. The monitoring component 1108 may monitor the PDCP counter values comprises monitoring the PDCP counter values at an SCG RLC layer of the UE. The monitoring component 1108 may detect no out-of-order PDCP counter value over a time duration.

In some aspects, the monitoring component 1108 may include one or more antennas, a demodulator, a MIMO detector, a receive processor, a modulator, a transmit MIMO processor, a transmit processor, a controller/processor, a memory, or a combination thereof, of the UE described above in connection with FIG. 2.

The control component 1110 may control a PDCP mode of the UE based at least in part on the monitoring of the PDCP counter values. The control component 1110 may deactivate the PDCP mode for a time duration based at least in part on the detection of the out-of-order PDCP counter value. The control component 1110 may deactivate the PDCP mode until an end of a connected mode session, or the control component 1110 may deactivate the PDCP mode for a cell or a PLMN based at least in part on the cell or the PLMN experiencing a number of PDCP mode deactivations that satisfies a threshold. The control component 1110 may activate the PDCP mode based at least in part on the detection of no out-of-order PDCP counter value over the time duration. The control component 1110 may activate the PDCP mode from a default setting in which the PDCP mode is deactivated. The control component 1110 may deactivate the PDCP mode from a default setting in which the PDCP mode is activated, wherein the PDCP mode is activated by default for UM bearers. The control component 1110 may deactivate the PDCP mode after a handover of the UE. The control component 1110 may deactivate the PDCP mode after the UE changes from a split bearer associated with dual connectivity to a non-split bearer associated with single connectivity, or changes from a non-split bearer associated with single connectivity to a split bearer associated with dual connectivity.

The control component 1110 may detect a gap in which a PDCP packet is not received; determine that a PDCP counter value associated with the gap is less than a serving RLC PDCP counter value at an expiry of a time duration, thereby indicating that the PDCP packet is not expected to be received at the UE; and send one or more PDCP packets following the gap to an application of the UE without waiting to receive the PDCP packet associated with the gap.

The control component 1110 may detect a gap in which a PDCP packet is not received; determine that a PDCP buffer memory satisfies a threshold; determine, when the PDCP buffer memory satisfies the threshold, that a PDCP counter value associated with the gap is less than a serving RLC PDCP counter value at an expiry of a time duration, thereby indicating that the PDCP packet is not expected to be received at the UE; and send one or more PDCP packets following the gap to an application of the UE without waiting to receive the PDCP packet associated with the gap.

In some aspects, the control component 1110 may include one or more antennas, a demodulator, a MIMO detector, a receive processor, a modulator, a transmit MIMO processor, a transmit processor, a controller/processor, a memory, or a combination thereof, of the UE described above in connection with FIG. 2.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

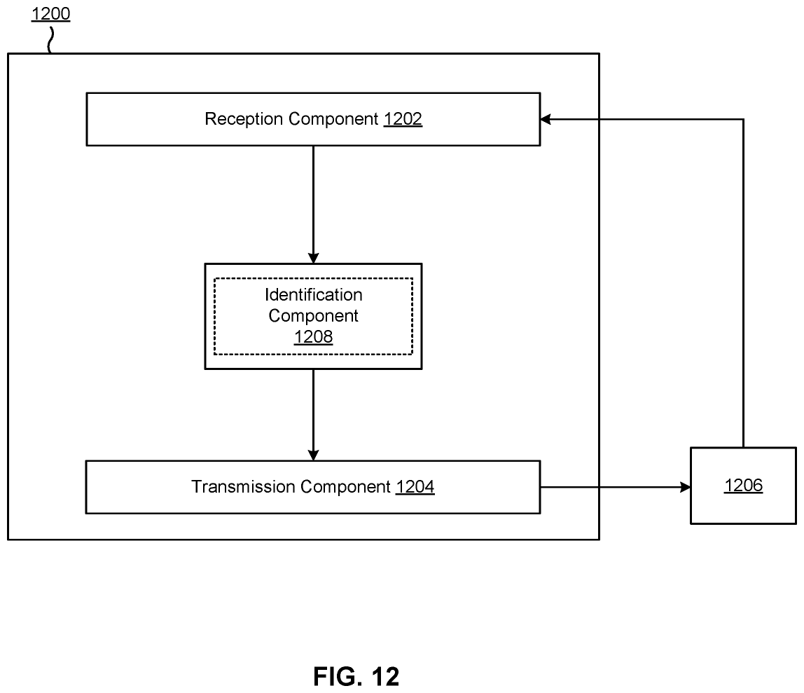

FIG. 12 is a block diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include an identification component 1208, among other examples.

In some aspects, the apparatus 1200 may be configured to perform one or more operations described herein in connection with FIGS. 7-9. Additionally or alternatively, the apparatus 1200 may be configured to perform one or more processes described herein, such as process 1000 of FIG. 10. In some aspects, the apparatus 1200 and/or one or more components shown in FIG. 12 may include one or more components of the base station described above in connection with FIG. 2. Additionally, or alternatively, one or more components shown in FIG. 12 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the base station described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the base station described above in connection with FIG. 2. In some aspects, the transmission component 1204 may be co-located with the reception component 1202 in a transceiver.

The identification component 1208 may identify PDCP counter values associated with PDCP packets. In some aspects, the identification component 1208 may include one or more antennas, a demodulator, a MIMO detector, a receive processor, a modulator, a transmit MIMO processor, a transmit processor, a controller/processor, a memory, or a combination thereof, of the base station described above in connection with FIG. 2. The transmission component 1204 may transmit the PDCP packets and the PDCP counter values to a UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: monitoring packet data convergence protocol (PDCP) counter values associated with PDCP packets; and controlling a PDCP mode of the UE based at least in part on the monitoring of the PDCP counter values.

Aspect 2: The method of Aspect 1, wherein the PDCP mode enables the UE to deliver, to an application of the UE, one or more PDCP packets without waiting for a time duration to expire, wherein the one or more PDCP packets follow a gap in which a PDCP packet is not expected to be received at the UE.

Aspect 3: The method of any of Aspects 1 through 2, wherein: monitoring the PDCP counter values comprises detecting an out-of-order PDCP counter value, wherein the out-of-order PDCP counter value is associated with an in-order radio link control (RLC) counter value; and controlling the PDCP mode comprises deactivating the PDCP mode for a time duration based at least in part on the detection of the out-of-order PDCP counter value.

Aspect 4: The method of any of Aspects 1 through 3, wherein monitoring the PDCP counter values comprises monitoring the PDCP counter values at a master cell group (MCG) radio link control (RLC) layer of the UE.

Aspect 5: The method of any of Aspects 1 through 4, wherein monitoring the PDCP counter values comprises monitoring the PDCP counter values at a secondary cell group (SCG) radio link control (RLC) layer of the UE.

Aspect 6: The method of any of Aspects 1 through 5, wherein controlling the PDCP mode comprises deactivating the PDCP mode until an end of a connected mode session, or deactivating the PDCP mode for a cell or a public land mobile network (PLMN) based at least in part on the cell or the PLMN experiencing a number of PDCP mode deactivations that satisfies a threshold.

Aspect 7: The method of any of Aspects 1 through 6, wherein: monitoring the PDCP counter values comprises detecting no out-of-order PDCP counter value over a time duration; and controlling the PDCP mode comprises activating the PDCP mode based at least in part on the detection of no out-of-order PDCP counter value over the time duration.

Aspect 8: The method of any of Aspects 1 through 7, wherein: controlling the PDCP mode comprises activating the PDCP mode; and activating the PDCP mode comprises: detecting a gap in which a PDCP packet is not received; determining that a PDCP counter value associated with the gap is less than a serving radio link control (RLC) PDCP counter value at an expiry of a time duration, thereby indicating that the PDCP packet is not expected to be received at the UE; and sending one or more PDCP packets following the gap to an application of the UE without waiting to receive the PDCP packet associated with the gap.

Aspect 9: The method of any of Aspects 1 through 8, wherein: controlling the PDCP mode comprises activating the PDCP mode; and activating the PDCP mode comprises: detecting a gap in which a PDCP packet is not received; determining that a PDCP buffer memory satisfies a threshold; determining, when the PDCP buffer memory satisfies the threshold, that a PDCP counter value associated with the gap is less than a serving radio link control (RLC) PDCP counter value at an expiry of a time duration, thereby indicating that the PDCP packet is not expected to be received at the UE; and sending one or more PDCP packets following the gap to an application of the UE without waiting to receive the PDCP packet associated with the gap.

Aspect 10: The method of any of Aspects 1 through 9, wherein controlling the PDCP mode comprises activating the PDCP mode from a default setting in which the PDCP mode is deactivated.

Aspect 11: The method of any of Aspects 1 through 10, wherein controlling the PDCP mode comprises deactivating the PDCP mode from a default setting in which the PDCP mode is activated, wherein the PDCP mode is activated by default for Unacknowledged Mode (UM) bearers.

Aspect 12: The method of any of Aspects 1 through 11, wherein controlling the PDCP mode comprises deactivating the PDCP mode after a handover of the UE.

Aspect 13: The method of any of Aspects 1 through 12, wherein controlling the PDCP mode comprises deactivating the PDCP mode after the UE changes from a split bearer associated with dual connectivity to a non-split bearer associated with single connectivity, or changes from a non-split bearer associated with single connectivity to a split bearer associated with dual connectivity.

Aspect 14: The method of any of Aspects 1 through 13, wherein the PDCP counter values each includes a respective hyper frame number (HFN) and a respective sequence number (SN).

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
monitoring packet data convergence protocol (PDCP) counter values associated with PDCP packets; and
controlling a PDCP mode of the UE based at least in part on the monitoring of the PDCP counter values.

2. The method of claim 1, wherein the PDCP mode enables the UE to deliver, to an application of the UE, one or more PDCP packets without waiting for a time duration to expire, wherein the one or more PDCP packets follow a gap in which a PDCP packet is not expected to be received at the UE.

3. The method of claim 1, wherein:
monitoring the PDCP counter values comprises detecting an out-of-order PDCP counter value, wherein the out-of-order PDCP counter value is associated with an in-order radio link control (RLC) counter value; and
controlling the PDCP mode comprises deactivating the PDCP mode for a time duration based at least in part on the detection of the out-of-order PDCP counter value.

4. The method of claim 1, wherein monitoring the PDCP counter values comprises monitoring the PDCP counter values at a master cell group (MCG) radio link control (RLC) layer of the UE.

5. The method of claim 1, wherein monitoring the PDCP counter values comprises monitoring the PDCP counter values at a secondary cell group (SCG) radio link control (RLC) layer of the UE.

6. The method of claim 1, wherein controlling the PDCP mode comprises deactivating the PDCP mode until an end of a connected mode session, or deactivating the PDCP mode for a cell or a public land mobile network (PLMN) based at least in part on the cell or the PLMN experiencing a number of PDCP mode deactivations that satisfies a threshold.

7. The method of claim 1, wherein:
monitoring the PDCP counter values comprises detecting no out-of-order PDCP counter value over a time duration; and
controlling the PDCP mode comprises activating the PDCP mode based at least in part on the detection of no out-of-order PDCP counter value over the time duration.

8. The method of claim 1, wherein:
controlling the PDCP mode comprises activating the PDCP mode; and
activating the PDCP mode comprises:
detecting a gap in which a PDCP packet is not received;
determining that a PDCP counter value associated with the gap is less than a serving radio link control (RLC) PDCP counter value at an expiry of a time duration, thereby indicating that the PDCP packet is not expected to be received at the UE; and
sending one or more PDCP packets following the gap to an application of the UE without waiting to receive the PDCP packet associated with the gap.

9. The method of claim 1, wherein:
controlling the PDCP mode comprises activating the PDCP mode; and
activating the PDCP mode comprises:
detecting a gap in which a PDCP packet is not received;
determining that a PDCP buffer memory satisfies a threshold;
determining, when the PDCP buffer memory satisfies the threshold, that a PDCP counter value associated with the gap is less than a serving radio link control (RLC) PDCP counter value at an expiry of a time duration, thereby indicating that the PDCP packet is not expected to be received at the UE; and
sending one or more PDCP packets following the gap to an application of the UE without waiting to receive the PDCP packet associated with the gap.

10. The method of claim 1, wherein controlling the PDCP mode comprises activating the PDCP mode from a default setting in which the PDCP mode is deactivated.

11. The method of claim 1, wherein controlling the PDCP mode comprises deactivating the PDCP mode from a default setting in which the PDCP mode is activated, wherein the PDCP mode is activated by default for Unacknowledged Mode (UM) bearers.

12. The method of claim 1, wherein controlling the PDCP mode comprises deactivating the PDCP mode after a handover of the UE.

13. The method of claim 1, wherein controlling the PDCP mode comprises deactivating the PDCP mode after the UE changes from a split bearer associated with dual connectivity to a non-split bearer associated with single connectivity, or changes from a non-split bearer associated with single connectivity to a split bearer associated with dual connectivity.

14. The method of claim 1, wherein the PDCP counter values each includes a respective hyper frame number (HFN) and a respective sequence number (SN).

15. A user equipment (UE) for wireless communication, comprising:
a memory; and
one or more processors, coupled to the memory, configured to:
monitor packet data convergence protocol (PDCP) counter values associated with PDCP packets; and
control a PDCP mode of the UE based at least in part on the monitoring of the PDCP counter values.

16. The UE of claim 15, wherein the PDCP mode enables the UE to deliver, to an application of the UE, one or more PDCP packets without waiting for a time duration to expire, wherein the one or more PDCP packets follow a gap in which a PDCP packet is not expected to be received at the UE.

17. The UE of claim 15, wherein:
the one or more processors, to monitor the PDCP counter values, are configured to detect an out-of-order PDCP counter value, wherein the out-of-order PDCP counter value is associated with an in-order radio link control (RLC) counter value; and
the one or more processors, to control the PDCP mode, are configured to deactivate the PDCP mode for a time duration based at least in part on the detection of the out-of-order PDCP counter value.

18. The UE of claim 15, wherein the one or more processors, to monitor the PDCP counter values, are configured to monitor the PDCP counter values at a master cell group (MCG) radio link control (RLC) layer of the UE.

19. The UE of claim 15, wherein the one or more processors, to monitor the PDCP counter values, are configured to monitor the PDCP counter values at a secondary cell group (SCG) radio link control (RLC) layer of the UE.

20. The UE of claim 15, wherein the one or more processors, to control the PDCP mode, are configured to deactivate the PDCP mode until an end of a connected mode session, or deactivate the PDCP mode for a cell or a public land mobile network (PLMN) based at least in part on the cell or the PLMN experiencing a number of PDCP mode deactivations that satisfies a threshold.

21. The UE of claim 15, wherein:
the one or more processors, to monitor the PDCP counter values, are configured to detect no out-of-order PDCP counter value over a time duration; and
the one or more processors, to control the PDCP mode, are configured to activate the PDCP mode based at least in part on the detection of no out-of-order PDCP counter value over the time duration.

22. The UE of claim 15, wherein:
the one or more processors, to control the PDCP mode, are configured to activate the PDCP mode; and
the one or more processors, to activate the PDCP mode, are configured to:
detect a gap in which a PDCP packet is not received;
determine that a PDCP counter value associated with the gap is less than a serving radio link control (RLC) PDCP counter value at an expiry of a time duration, thereby indicating that the PDCP packet is not expected to be received at the UE; and
send one or more PDCP packets following the gap to an application of the UE without waiting to receive the PDCP packet associated with the gap.

23. The UE of claim 15, wherein:
the one or more processors, to control the PDCP mode, are configured to activate the PDCP mode; and
the one or more processors, to activate the PDCP mode, are configured to:
detect a gap in which a PDCP packet is not received;
determine that a PDCP buffer memory satisfies a threshold;
determine, when the PDCP buffer memory satisfies the threshold, that a PDCP counter value associated with the gap is less than a serving radio link control (RLC) PDCP counter value at an expiry of a time duration, thereby indicating that the PDCP packet is not expected to be received at the UE; and
send one or more PDCP packets following the gap to an application of the UE without waiting to receive the PDCP packet associated with the gap.

24. The UE of claim 15, wherein the one or more processors, to control the PDCP mode, are configured to activate the PDCP mode from a default setting in which the PDCP mode is deactivated.

25. The UE of claim 15, wherein the one or more processors, to control the PDCP mode, are configured to deactivate the PDCP mode from a default setting in which the PDCP mode is activated, wherein the PDCP mode is activated by default for Unacknowledged Mode (UM) bearers.

26. The UE of claim 15, wherein the one or more processors, to control the PDCP mode, are configured to deactivate the PDCP mode after a handover of the UE.

27. The UE of claim 15, wherein the one or more processors, to control the PDCP mode, are configured to deactivate the PDCP mode after the UE changes from a split bearer associated with dual connectivity to a non-split bearer associated with single connectivity, or changes from a non-split bearer associated with single connectivity to a split bearer associated with dual connectivity.

28. The UE of claim 15, wherein the PDCP counter values each includes a respective hyper frame number (HFN) and a respective sequence number (SN).

29. A non-transitory computer-readable medium storing a set of instructions for wireless communication, the set of instructions comprising:
one or more instructions that, when executed by one or more processors of a user equipment (UE), cause the UE to:
monitor packet data convergence protocol (PDCP) counter values associated with PDCP packets; and
control a PDCP mode of the UE based at least in part on the monitoring of the PDCP counter values.

30. An apparatus for wireless communication, comprising:
means for monitoring packet data convergence protocol (PDCP) counter values associated with PDCP packets; and
means for controlling a PDCP mode of the apparatus based at least in part on the monitoring of the PDCP counter values.
